(19) United States
(12) Patent Application Publication
(10) Pub. No.: US 2007/0143453 A1
(43) Pub. Date: Jun. 21, 2007

(54) System and method for configuring a packet-switched network based on a network quality survey

(75) Inventor: Alexander Lisheng Huang, Austin, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/313,563

(22) Filed: Dec. 21, 2005

(51) Int. Cl. G06F 15/177

(52) U.S. Cl. 709/220

(57) ABSTRACT

A method is presented for configuring a packet-switched network. The method provides for emulating a variable quality of service for the network and collecting survey data for the variable quality of service. In another embodiment a system is presented for configuring a packet-switched network based on quality of service survey data.

### BACKGROUND OF THE DISCLOSURE

1. Field of the Disclosure

The present invention relates to the field of packet-switched networks.

2. Background

In addition to traditional data transport, packet-switched networks today provide a variety of real-time multimedia services including but not limited to telephony and video conferencing. The ideal transport for these real-time multimedia service data is a guaranteed timely and orderly delivery of packets as steady streams. In a typical packet-switched network using a communication protocol such as the internet protocol (IP), however, timely delivery of packets is not guaranteed due to lack of totally deterministic traffic distribution in the network. Congestion is also possible in an IP based packet-switched network, which may occur stochastically at a given routing node of the network to delay packet delivery. If sufficient capacity is not available for some packets at a given node and a given moment, the packets may be discarded or detoured around the node via another route in the network, which may delay the packet arrival time. Dropping or rerouting of packets can result in lower quality of service due to loss, delay, and delay variation of voice or video data packet transmissions, called “jitter.”

Thus, network technology that increases the capacity of networks can improve the network quality of service and decrease dropped cells or packets resulting from network congestion. Another way to improve network capacity is to introduce some deterministic behavior of the packet transport over the network by routing system capacity reservation, or packet queuing prioritization, etc. All these improvements result in higher capacity and/or higher quality of the network equipment, and thus unavoidably raise the cost of the services delivered by the network. Service pricing is very competitive. In the case of packet multimedia services, at a certain point, high costs of a network can render the services the network supports non-profitable. On the other hand, a poorly equipped network can cause the service quality to be unacceptable to so many customers that the service loses the customers and becomes non-profitable. Therefore, finding a near optimal middle point where both the cost and quality are acceptable is useful for planning a profitable network.

The service pricing space is competitive due to service market competition and the high cost curve of new technologies for improving packet delivery quality. More importantly, determinations as to whether the quality of a multimedia service is acceptable to customers are subjective and relative to pricing. To date, there is no universally agreed upon rule for an acceptable quality level of IP real-time multimedia services, such as IP telephony, mainly because there are not sufficient statistics available from existing IP services in the market to establish such a rule. Therefore, a method and system which simulate a real network and some IP service at a given quality level is desirable for collecting statistics which indicate subjective acceptance by the customers relative to certain pricing schemes. A network can be built to near optimal quality and substantially minimum cost levels based on the statistics so that the services supported by such network can be more profitable.

### BRIEF DESCRIPTION OF THE DRAWINGS

For detailed understanding of the illustrative embodiment, references should be made to the following detailed description of an illustrative embodiment, taken in conjunction with the accompanying drawings, in which like elements have been given like numerals, wherein:

FIG. 1 is a schematic diagram depicting an illustrative embodiment showing a survey participant, a packet-switched network emulator, a data base and a packet-switched network;

FIG. 2 is a schematic diagram depicting another illustrative embodiment showing a survey participant, a packet-switched network, emulator and a data base;

FIG. 3 is a flow chart illustrating determination of a minimum quality of service for an emulated network;

FIG. 4 is a flow chart illustrating determination of a minimum quality of service acceptable based on combinations of impairments;

FIG. 5 is a flow chart showing functions performed in an illustrative embodiment;

FIG. 6 is an illustration of a data structure for storing a network instance of an illustrative embodiment;

FIG. 7 is a flow chart illustrating an embodiment for preparing a preliminary list of quality grades;

FIG. 8 is a flow chart illustrating an embodiment for determining lowest acceptable quality grades;

FIG. 9 is a flow chart illustrating an embodiment for determining revenue opportunities for multiple quality grades;

FIG. 10 is a flow chart illustrating an embodiment for determining network configuration; and

FIG. 11 is a diagrammatic representation of a machine in the form of a computer system within which a set of instructions, when executed, may cause the machine to perform any one or more of the methodologies of the present disclosure.

### DETAILED DESCRIPTION OF THE ILLUSTRATIVE EMBODIMENTS

The illustrative embodiments are not meant to limit the application of the embodiment to a particular service or network design, as an embodiment can be applied to any network providing a variety of consumer services, including but not limited to voice communications, data and multimedia interactive applications, audio conferencing, video conferencing, and media streaming.

The illustrative embodiments disclosed herein enable service providers to take surveys of network quality of service using an emulated network. These surveys can help the service provider to design a network suitable to their subscribers' needs at an acceptable cost. There are tradeoffs between quality of service and network cost in providing services over a packet-switched network. The higher the quality provided, the more expensive the network becomes.

In one embodiment, a method is presented for configuring a packet-switched network. The method provides for emulating a variable quality of service for the network and collecting survey data for the variable quality of service. In another embodiment a method is presented for storing a first network configuration in an initial first network instance for the packet-switched network in a data base, and configuring the first network instance to a second network instance based on the survey data.

In another aspect of a particular embodiment, a method is presented for providing a declining quality of service. In another embodiment, the method further provides for determining a minimum quality of service from the survey data of a minimum quality of service.

In another aspect of a particular embodiment, a method is presented for emulating a plurality of quality of service levels above the minimum quality of service associated with different pricing schemes, and collecting survey data to determine a number of “subscribers” for each of the quality of service levels.

In another aspect of a particular embodiment, a method is presented for configuring the first network instance to the second network instance based on a cost. In another embodiment the cost further is calculated as a cost of providing a packet-switched network according to the second network instance minus revenue based on the number of “subscribers” for each quality of service level for the second network instance. In another embodiment, the revenue further is a sum of the revenue for each quality of service level. In another embodiment, the revenue for a quality of service level is equal to the number of “subscribers” for that quality of service level multiplied by a fee for such quality of service level.

In another aspect of a particular embodiment, a method is presented wherein a variable quality of service is provided by a variable weight impairment selected from the set consisting of but not limited to packet transport delay, loss, and jitter. In another aspect of a particular embodiment a method is presented having a variable quality of service provided by a variable impairment selected from the set consisting of a combination of delay, loss, and jitter.

In another embodiment, a system is presented including a database for storing a configuration for a packet-switched network in a first network instance; a network emulator that emulates the configuration for the packet-switched network; and a control system with access to the first network instance in the database, the control system having a first interface to store the first network instance in the data base, a second interface to command the network emulator emulate a variable quality of service for the first network instance, a third interface to receive survey data for the variable quality of service and a fourth interface to store a configured second network instance based on the survey data. In another embodiment of the system, the control system further includes a fifth interface to store a minimum quality of service determined from the survey data.

In another embodiment of the system, the control system further includes a sixth interface to send a command to the network emulator to emulate quality of service levels above the minimum quality of service and collect survey data to determine a number of subscribers for each of the quality of service levels. In another embodiment of the system, the control system further includes a seventh interface to store a configured second network instance based on a substantially minimum cost of providing the packet-switched network. In another embodiment of the system, the control system further includes an eighth interface to store a second network instance based on the revenue minus the cost.

In another embodiment of the system, the revenue is a sum of the revenue for each quality of service level, wherein the revenue for each quality of service level is derived from the number of projected subscribers who are satisfied for said each quality of service level and the subscription fee for each quality of service level. In another embodiment the control system further includes a ninth interface to send a command to the network emulator to vary a weight for an impairment selected from a set consisting of delay, loss, jitter and error.

In another embodiment, a packet-switched network is presented containing a group of network nodes, a group of high speed digital communication links connecting the group of network nodes, and a group of network components placed in each of the group of network nodes. The network components are placed in a selected network node based on a network instance configured using a computer program. The computer program contains instructions to store an initial network configuration for the packet-switched network in a first network instance in a data base, instructions to emulate a variable quality of service for the first network instance, instructions to collect survey data for the variable quality of service and instructions to configure the first network instance to a second network instance based on the survey data.

In another embodiment the computer program includes instructions to determine a minimum quality of service from the survey data. In another embodiment the computer program includes instructions to emulate a plurality of quality of service levels above the minimum quality of service and collect further survey data to determine a number of subscribers for each of the plurality of quality of service levels. In another embodiment the computer program includes instructions to configure the initial first network instance to the second network instance based on a substantially minimum cost. In another embodiment the computer program includes instructions to calculate the cost as a cost of providing an actual packet-switched network according to the second network. In another embodiment the computer program includes instructions to calculate revenue and configuring the second network instance based on the revenue minus the cost. In another embodiment the computer program includes instructions to vary a weight for an impairment selected from a set consisting of delay, loss, jitter and error.

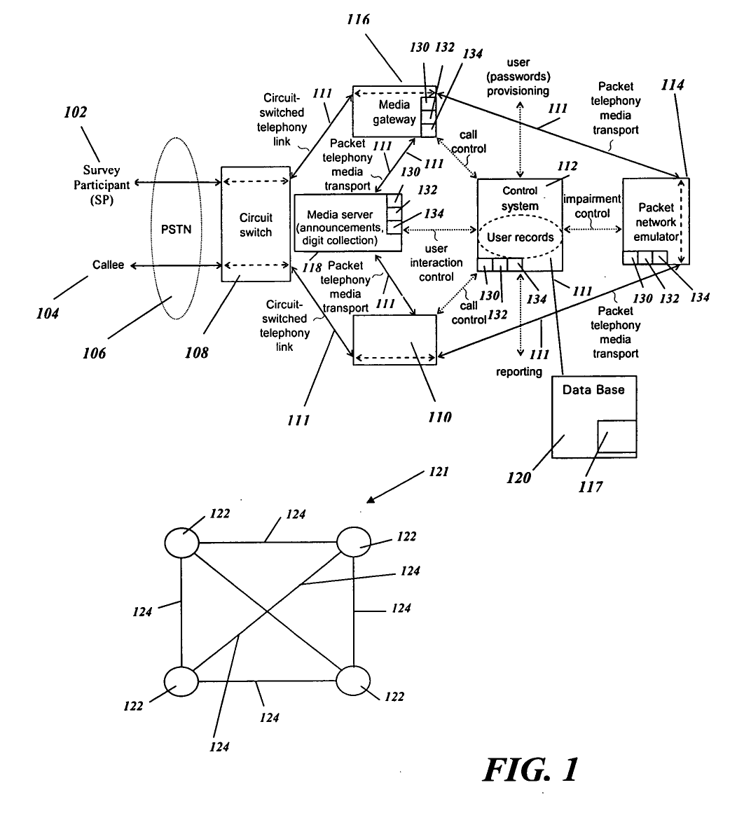

Turning now to FIG. 1, an embodiment of a system 100 is shown in which a survey participant (SP) (or “subject” hereinafter) 102 calls into a circuit switch 108. The circuit switch 108 can be a traditional call routing system used in the public-switched telephone network (PSTN). The circuit switch 108 can also be a user furnished equipment with the same functionality and connected to the PSTN. The circuits switch 108 supports circuit-switched external interfaces such as Integrated Service Digital Network (ISDN).

Media gateways 110 and 116 are provided as a subsystem that converts circuit-switched telephony calls into packet-switched telephony calls, and vice versa. The media gateways 110, 116 are controlled by an external control system 112 via protocols such as media gateway control protocol (MGCP) or International Telecommunications Union-Telecommunications Standardization Sector (ITU-T) H.248. The media gateways support both circuit-switched external interfaces such as ISDN and packet-switched external interfaces such as the Internet Protocol (IP) over Ethernet. In an illustrative embodiment, the control system can include a processor 130 and a memory 132 coupled to the processor 130. In a particular embodiment, the memory 132 can include a computer program that is embedded therein that can include instructions to perform one or more of the method steps described herein. Additionally a data base 134 can be coupled to the processor 130.

A Media Server 118 is provided as a subsystem that can record and playback voice, collect and generate telephony tones, and, optionally, recognize and synthesize speech, and mix multiple calls, etc. The media server can reside on a processor with memory and input/output. The media server can be controlled by an external controlling system 112 via protocols such as MGCP and ITU-T H.248 or it can execute instructions given in text file form such as Voice XML. Media server 118 supports either or both circuit-switched external interfaces such as ISDN and packet-switched external interfaces such as Internet Protocol (IP) over Ethernet. In an illustrative embodiment the media server can include a processor 130 and a memory 132 coupled to the processor 130. In a particular embodiment, the memory 132 can include a computer program that is embedded therein that can include instructions to perform one or more of the method steps described herein. Additionally a data base 134 can be coupled to the processor 130.

A packet-switched network emulator (PNE) 114 is provided as a subsystem with a bridging and/or routing function. In an illustrative embodiment, the PNE can include the processor 130 and a memory 132 coupled to the processor 130. In a particular embodiment, the memory 132 can include a computer program that is embedded therein that can include instructions to perform one or more of the melted steps described herein. Additionally a data base 134 can be coupled to processor 130. The PNE can reside on a processor with memory and input/output. The PNE 114 emulates impairments to network transmission for the network instance stored in the data base 120 associated with control system 112. The PNE applies selected impairments to the passing packets for a network configuration stored in the network performance grade data structure 117 in the database 120.

The PNE has access to the data base 120 via control system 112 for network configurations of network nodes, network elements, network element configurations within the network nodes and associated impairments for each network element configuration. Packet-switched network transmission impairments may include, but are not limited to impairments such as delay, loss, jitter, and error, etc. The PNE applies different levels and/or combinations of the impairments by operational configuration and/or external system control and allows survey participants to choose a minimum network quality of service. The PNE supports packet-switched external interfaces such as IP over Ethernet. The system 100 further includes communication links 111 to enable communication between circuit switch 108, media gateways 110 and 116, media server 118, control system 112, database 120 and PNE 114.

Control system 112 controls the system 100. The control system 112 can reside on a suitable processor with memory and input/output. The control system 112 provides logic and data to instruct the media gateway(s) 116, 118 to accept telephone calls from a survey participant (SP), and route the survey participant calls through the PNE 114 to a call recipient. The control system 112 also controls the PNE 114 for applying various impairments to simulate packet transmission as appropriate to gauge the user perception and tolerance to variable quality of service levels associated with a given network instance. The control system 112 also controls the media server in order to provide instructions to the survey participants as well as to collect their opinions for the survey. The control system 112 supports a packet-switched network interface, such as Ethernet, in order to connect to all other subsystems. The control system 112 applies business rules stored in data base 120 associated with control system 112 to configure the network data structure 117 stored in data base 120 based on survey data and network cost.

A physical packet-switched network 121 can be implemented according to the network data structure 117. The packet-switched network 121 includes network node 122 and network node connections 124 between the network nodes. Network elements such as routers, media gateways, media proxies, media servers, etc. are placed at the network nodes 122 and represented in the data structure 117.

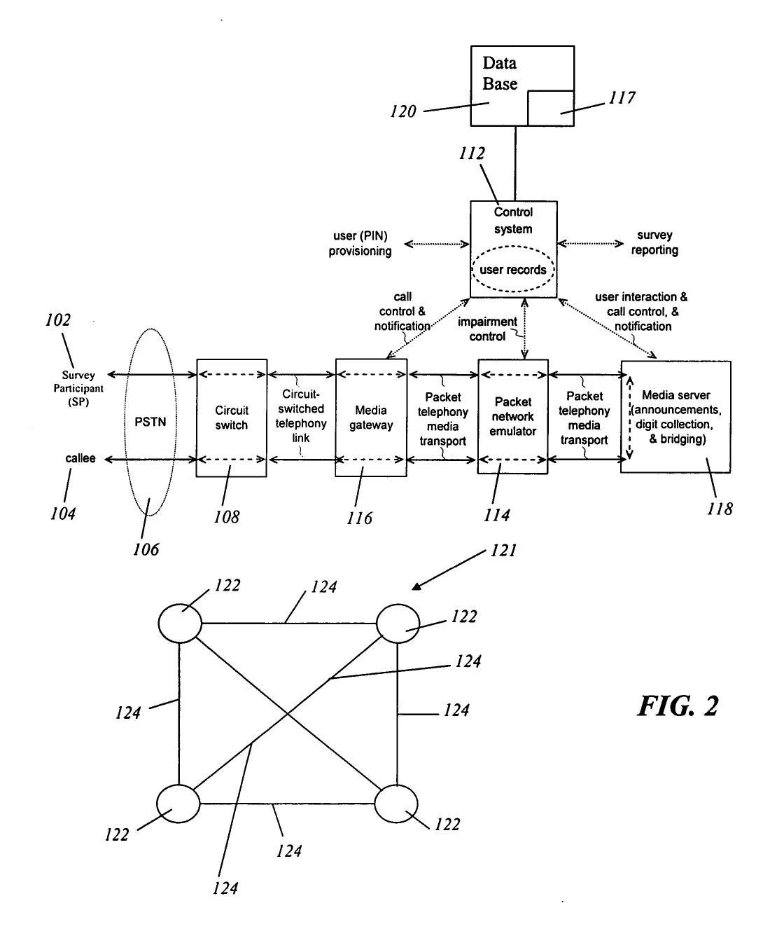

FIG. 2 illustrates an embodiment that is streamlined to accommodate a single media gateway (MG) 116 and a single circuit-switched telephony link. The embodiment of FIG. 2 also enables bridging out the PNE 114 to remove it from the connection between an SP 102 (also referred to as a survey subject) and called party or callee 104 when impairments are no longer desired for a survey call.

In the illustrative embodiment of FIG. 2, an SP 102 can be given a toll-free dial-in number and a unique personal identification number (PIN) number (for tracking purposes). The SP 102 can then dial in to the system 100 through the PSTN 106 at anytime. When the SP 102 calls in via the circuit switch 108 the system prompts the caller for the PIN and retrieves the caller record. This PIN enables an SP to make a given number of calls, which may provide more accurate data from the SP than a single survey call to ensure that the SP understands the procedure of the survey.

As shown in FIG. 1 and FIG. 2, the control system 112 has access to database 120 and maintains the status of all SPs in the data base 120. The control system 112 also controls the media gateways (110, 116), media server 118, and PNE 114. The control system 112 connects the SP 102 to a callee 104 of the SP's choice. The controller interacts with the SP 102 and callee 104, and to change the impairment settings of the PNE. The SP's scores for quality of service for the emulated network impairments are collected via the media server 118 and are stored or reported by the control system 112 in the data base 120. The system 100 is programmed to operate continuously and accept calls from any telephone as long as the telephone is connected to the public switched telephony network and is not a source of major voice quality degradations.

In a first illustrative scenario, an SP is queried to select an acceptable quality of service level for the network determined from a set of quality of service levels for the network. SPs may experience, for example, 3 to 4 quality of service levels, and are asked if the quality of each level is acceptable, given that the service is otherwise equally attractive based on price and functionality. First, the SP 102 is given a dial-in number, a personal identification number (PIN), and background material and instructions. For example, a SP may be instructed as follows: “You can make 3 free telephone calls. In return, we ask that you tell us your opinion on the voice quality of four short telephone service grade samplings. By calling someone you select, you will be sampling 4 different grades of telephone services, ‘W’, ‘X’, ‘Y’, and ‘Z’. Each sample quality of service level has a distinct range of voice quality. We will introduce each of these service grades during your call for only one minute each. All you need to do is to keep talking with your called party, and observe the voice quality of your conversation. We will announce the quality of service level name at the beginning and end of each sampling minute and will ask you if the quality of level at that grade would be the acceptable to you at a given subscription fee. You can provide us with your answer by simply pressing a single key for ‘yes’ or ‘no’. After going through all four grades in about four minutes total, you will be finished with helping us and free to continue your conversation with your called party for 30 more minutes, at the highest voice quality and at no cost. At no time in the call is your conversation being recorded. Your call is completely private, like any other call you would make.”

It should be noted that to minimize call conditions that are outside of the desired range of the packet network emulation, calls can be restricted to, for example, those calls between PSTN end points that are not involved with wireless, international, or Internet telephony. Calls between other configurations (wireless, international, or Internet telephony) can be restricted. A telephony numbering plan database can be accessed by the controlling system to enforce this call restriction policy.

In another type of survey emphasizing relationships between quality and pricing, SPs sample 3-4 PNE emulated network quality of service levels. Each network quality of service level is tagged with a flat monthly subscription price, and callers are asked for a preference. Users are given 2-3 calls at no charge to experience the network quality of service levels. There is a quality of service sampling and selection section for a few minutes at the beginning of each survey call. Once the sampling is completed the survey participant is awarded with a 30-minute free call. First, the survey participant is given a dial-in number, a password, and a sheet of background information and instructions. For example, a SP may be instructed as follows: “You can make 3 calls at no charge. In return, please tell us about your “preference” of voice quality. By calling someone you select, you will be sampling 4 different quality of service levels, diamond, gold, silver, and bronze. Each sample quality of service has a different voice quality, which will take only one minute. All you need to do is to keep talking with your party, and observe the voice quality of your conversation. We will announce the service name and price at the beginning and end of each sampling minute. Then we will ask you which one would be the most attractive. After your single key selection, you are free to continue your conversation for up to 30 minutes at no charge. At no time throughout the call is your conversation being recorded. It is as private as any other call.”

The PNE 114 emulates network transmission impairments which can be associated with a packet-switched network instance 117 stored in database 120. Impairments include but are not limited to delay, loss, jitter and error, etc. Any existing or future packet switched network impairment can be emulated by a PNE. The initial packet-switched network configuration is emulated at different quality of service levels during the network quality of service surveys. In another embodiment, impairments are emulated without reference to a network instance.

A minimum quality of service can be determined from SP input based on the SP selections from an emulated variable quality of service for the network. The remaining network quality available above the minimum quality of service is then divided into quality of service levels for determination in a survey of how many SPs are interested in each network quality of service level and at what subscription price the SPs are willing to participate. Once a sufficient number of SPs have sampled and selected the network quality of service levels and subscription pricing, projected revenue for a given network instance may be determined.

In one illustrative embodiment, a minimum quality of service can be determined by subjecting SPs to a declining or degenerating quality of service. A declining quality of service can be emulated by starting a survey call with no impairment and increasing the impairment level to reduce the quality of service. SPs are asked to interrupt or respond with a spoken or key entry to determine when they perceive that the network quality of service has degenerated to an unacceptable level. The quality of service level to which the quality of service has declined when the SP responds with an input is equivalent to the minimum quality of service level for the network. An average minimum quality of service is determined from a group of SPs selections for minimum quality of service. A network quality of service band exists between the maximum or highest network quality of service level with no impairments and the minimum quality of service impairment level with highest tolerable impairment. This network quality of service band is divided into several quality of service levels. These quality of service levels are made available for selection by SPs at different network subscription fees during the survey. These network quality of service levels are presented to SPs to determine a cost efficient network configuration to provide the quality of service levels for the network at a substantial minimum cost.

The data base provides data on network configurations. The data includes but is not limited to network configuration cost, impairments and quality of service levels associated with the network configurations. The data also includes data on combinations of impairments at different impairment levels. Thus a set of business rules can be applied to the data base to determine a cost for a particular network configuration based on a desired quality of service. The network configuration is associated with an impairment level or combinations of impairment levels to achieve a desired group of quality of service levels for a given network configuration.

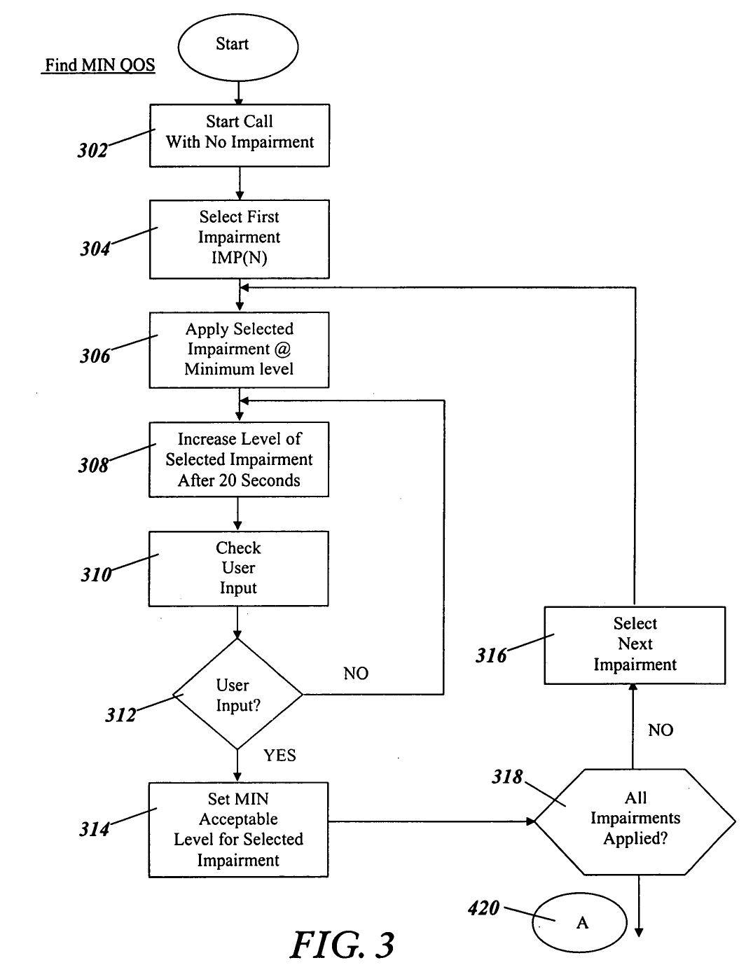

Turning now to FIG. 3 a flowchart 300 is shown illustrating a particular embodiment for finding a minimum quality of service for the emulated network. As shown in block 302 a survey call is started with no impairment. This no-impairment network instance represents the highest quality of service available for a given network sate. The SP is instructed to provide a spoken or keyed input when the quality of service has become unacceptable, that is, the level just below the minimum quality of service that is acceptable. The quality of service at the level when the survey participant provides the input is just below the minimum quality of service. In block 304 a first impairment M (1 of N impairments) is selected to be applied to the survey call. At block 306 the selected impairment M is applied to the survey call at a minimum impairment level. At block 308 the level of the impairment M (M of 1-N impairments) is increased after a set period, for example, 20 seconds. At block 310 the survey participant input is checked to determine if the survey participant has indicated that this quality of service level is a minimum quality of service. In block 312 if the survey participant has not generated an input, indicating that the quality of service is not at a minimum quality of service level, and the process returns to 308 and the level of the selected impairment M is increased again.

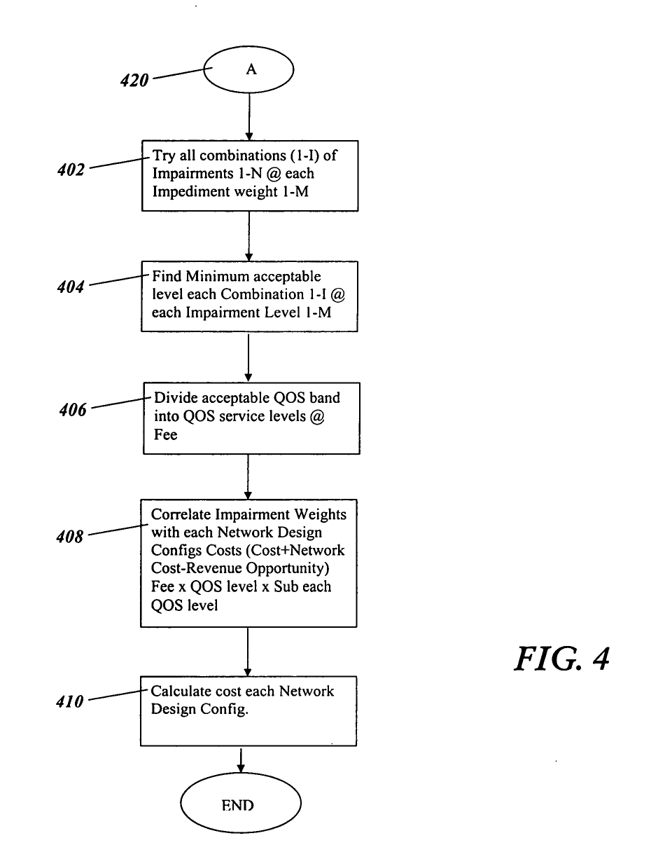

At decision block 310, a check is made for user input. If no input is detected the logic continues in the loop between block 312 and block 308 until a user input is detected. In block 314 when a user input is detected from block 312, the current level for impairment M is stored as the minimum acceptable level for impairment M. This minimum acceptable quality of service level for the currently selected impairment M is stored in the data base 120. The logic then proceeds to block 318 where it is determined whether all impairments (1-N) have been applied. If all impairments have been applied the particular embodiment proceeds to FIG. 4 block 320 and proceeds with finding the minimum quality of service level based on different combinations, 1-I of the 1-N impairments.

If it is determined that all impairments 1-N have not been applied in block 318, then the process proceeds to block 316 and selects the next impairment M (1 of N) to be applied to the survey call. The illustrative embodiment then proceeds to block 306 and applies the selected impairment at a minimum level and loops through block 312 increasing the impairment level until the SP indicates that the minimum acceptable quality of service based on a maximum tolerable level of the selected impairment has occurred.

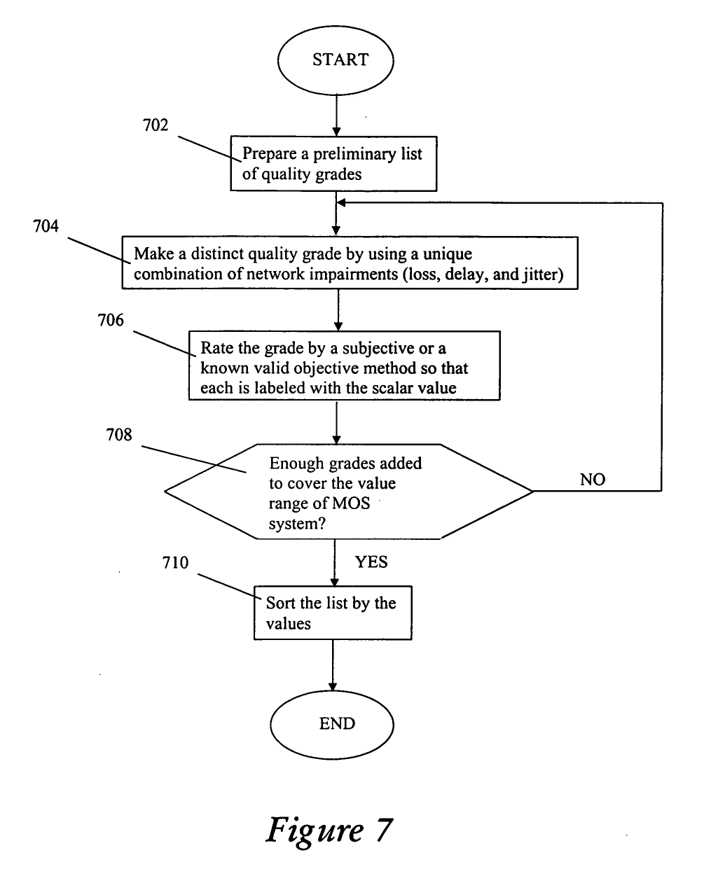

Alternatively, as discussed below, in connection with FIGS. 7-9 in another embodiment for each SP, the selection of remaining sample grades can be dynamically determined according to the response the SP has already given at any point. For example, for a 10-grade scale of quality, with grade 1 as the best and 10 the worst, the SPs can be given grade 6 to begin with. If a particular SP, SP1, judges it as “acceptable”, then the next sample point may be grade 9; whereas for another SP, SP2, who indicates that grade 6 is “unacceptable”, then the next sample point may be grade 3 instead. The third sampling grade may be in turn determined according to the first and second rating respective to the particular SP in the similar manner.

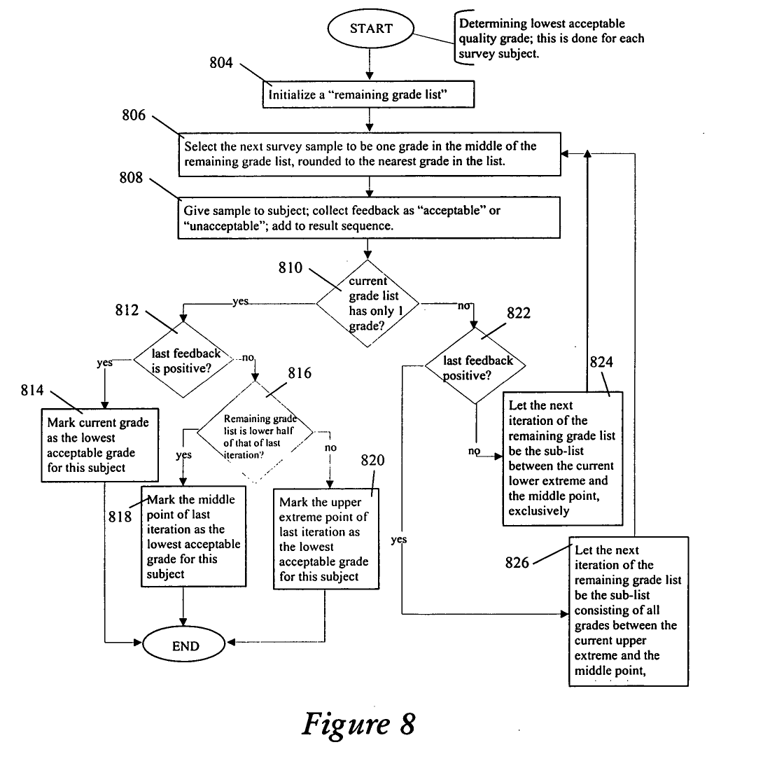

Once all impairments (1-N) have been applied to the survey call at block 318 the illustrative embodiment proceeds to block 320 FIG. 4 to determine the minimum quality of service acceptable based on combinations 1-I of the impairments (1-N) at various levels of the impairments. As shown in FIG. 4 the process picks up from FIG. 3 at connector 320. As shown in block 402 the embodiment applies all combinations 1-I of impairments 1-N at each impairment weight 1-W to the survey call. The weights 1-W can represent levels of a selected impairment at 25%, 50% and 75% of the maximum acceptable impairment level associated with the minimum quality of service level for each impairment. At block 404 the illustrative embodiment finds the minimum acceptable level for each impairment combination 1-I at each impairment level 1-W. Combinations 1-I represent all possible combinations for impairments 1-N at impairment weights 1-W. The process for finding the minimum acceptable combination 1-I at impairment weight 1-W is similar to the looping process shown in FIG. 3 wherein all combinations of impairments 1-N at weights 1-W are applied to a survey call at different combinations and different levels of each impairment in the combinations until a survey participant indicates a minimum quality of service has been achieved for each combination 1-I. Alternatively the processing of finding the minimum acceptable combination 1-I at impairment weight 1-W is similar to the process shown in FIG. 8.

Once the minimum quality of service has been determined for combinations 1-I, the remaining network quality of service band is divided into two, three, or four or more quality of service levels and assigned a particular subscription fee. The acceptable network quality of service band is that level of impairment between the minimum acceptable quality of service and that quality of service with no impairments.

At block 408 the illustrative embodiment correlates, the impairment weights 1-W with a network design configuration cost for each impairment weight. The network configuration cost may include costs of equipment and cost for providing the services for the quality levels for each impairment combination. The revenue opportunity generated by a network configuration in the network instance can be estimated as equal to a subscription fee for each quality of service level times the number of network subscribers at each quality of service level provided by a network configuration. The revenue opportunity is estimated for each network quality of service level in a network configuration so that a total revenue opportunity for a network configuration can be estimated. As shown in block 410 the embodiment then calculates a cost for each network configuration in a network instance and selects a network configuration based on the quality of service level acceptable for the projected subscribers to the network. The network may be configured to a substantially minimum cost based on the cost and/or revenue opportunity as discussed below.

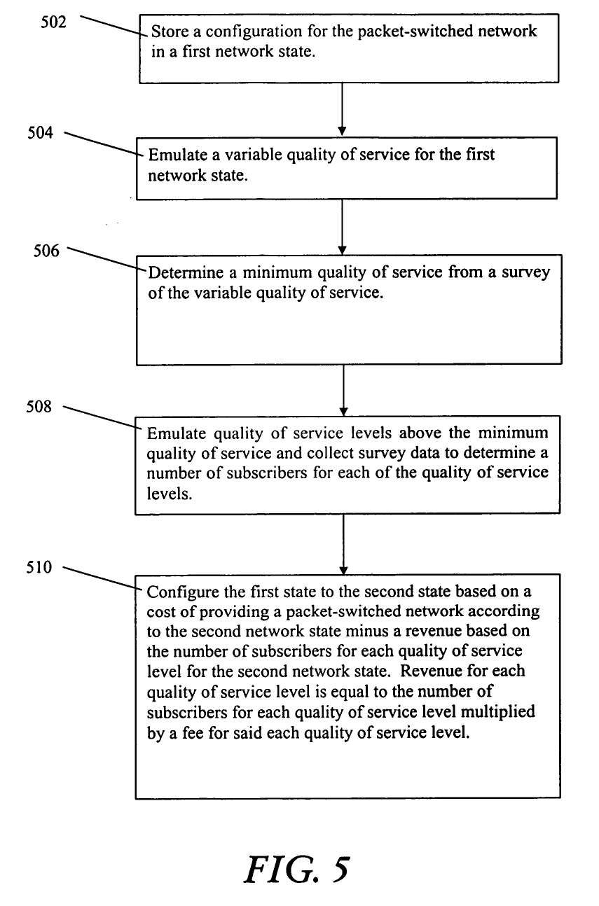

Turning now to FIG. 5, a flow chart for functions performed in an illustrative embodiment is shown. As shown in FIG. 5, in block 502 a configuration for the packet-switched network is stored in a first network instance. In block 504 a variable quality of service is emulated for the first network instance. In block 506 a minimum quality of service is determined from a survey of the variable quality of service. In block 508 a group of quality of service levels above the minimum quality of service is surveyed. Survey data is collected to determine a number of subscribers for each of the quality of service levels. In block 510 the first network instance is configured to a second network instance based on a cost of providing a packet-switched network according to the second network instance. The cost is adjusted by subtracting revenue for the quality of service level based on the number of subscribers for each quality of service level for the second network instance. Revenue for each quality of service level is estimated as equal to the number of subscribers for each quality level multiplied by a subscription fee for the quality of service level. A substantially minimum cost for a network design is sought by configuring a network whose performance meets the quality of service levels without the expense of providing surplus performance.

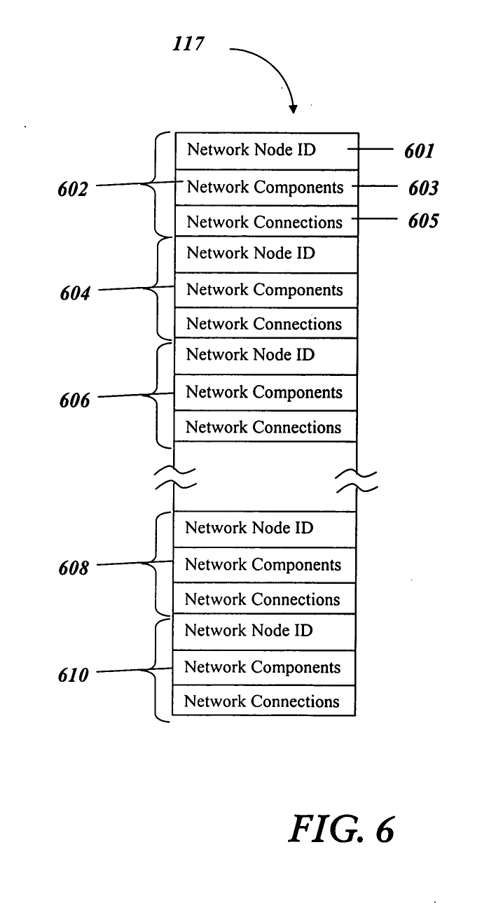

Turning now to FIG. 6, FIG. 6 illustrates a data structure 117 for representing a network configuration in a network instance. A set of data structure fields is shown associated with the network nodes 122 in a network configuration. There can be multiple instances of each network node associated with a unique identifier in the data structure 117 for uniquely representing multiple network nodes. Network components can be placed in any of the network nodes. Network components such as a server, router, digital signal processor or high speed link, if present in or associated with one or more of the network nodes 122 can be represented in the data structure 117. The network components specified as to type, size and speed in the type, size and speed field in the data structure. In addition, the network is described by the data structure of relations between nodes, known as connectivity.

The physical packet-switched network 121 is made up of network nodes 122, network connections 124 and network components placed inside of the network nodes 122. The physical packet-switched network 121 is laid out according to a network instance stored in the data structure 117. Additional fields can be added to the data structure to represent additional network elements such as nodes, communication links and other information associated with specifying a packet-switched network. The network instance is defined by fields in the data structure which define the network 121. Each network node 122 in the network 121 is defined by a group 602 of network node definition fields. Each group of network node definition fields includes but is not limited to a network node identifier field 601; network components field 603 and a network connections field 605.

Turning now to FIG. 7, FIG. 7 is a flow chart illustrating another embodiment for preparing a preliminary list of quality grades (used once for a generation of media data transport and application technology) at block 702. A distinct quality or service level or grade is made by providing a unique combination of network impairments (loss, delay, jitter and error) at block 704. The quality of service level or grade can be rated by a subjective (e.g., International Telecommunication Union Standards (ITU-T) P.800) or a known valid objective method (e.g., ITU-T P.862) so that each quality of service level or grade is labeled with a scalar value, e.g., a Mean Opinion Score (MOS) at block 706. It is determined if enough grades have been added to cover the value range of MOS system at block 708. Intermediate values between the two extremes are populated densely enough, but not too densely such that any more values added would be similar to the existing grades, or would make the number of grades too large. In general, the number of grades should be 2^{m}, where m is the maximum number of samples a survey subject can reasonably tolerate and effectively evaluate. If there are not enough grades at block 708 then the procedure returns to block 702. If there are enough grades at block 708 then the procedure continues on to block 710 to sort the list of grades by their values—into an “initial grade list” for a survey in the next procedure shown in FIG. 8.

Turning now to FIG. 8, FIG. 8 is a flow chart illustrating another embodiment for determining a lowest acceptable quality of service level or grade (used once for a generation of media data transport and application technology). At block 800 this procedure may or may not be integrated with the procedure illustrated in FIG. 7 and discussed above. If integrated, the two parts can be performed alternately and iteratively, so that each iteration refines and improves the list of quality of service levels or grades. At block 804 the remaining grade list is initialized which can be from the result (“initial grade list”) of the procedure illustrated in FIG. 7. A “remaining quality of service level or grade list” is made as the space for the subsequent sampling. The procedure selects the next survey sample to be one grade in the middle of the remaining grade list, rounded to the nearest grade in the list. Sampling is began for each SP, with one quality of service level or grade in the middle of the remaining grade list (e.g., 0.5 of the value range between the two extremes of the list), rounded to the nearest quality of service level or grade in the list at block 806. The procedure presents samples (quality of service levels) to a subject, collects feedback as “acceptable” or “unacceptable” and adds the feedback to the result sequence at block 808. After obtaining the feedback from the SP on each quality of service level or grade sampling, the feedback is used along with all previous feedback to determine the next “remaining quality of service level or grade list.”

If the current remaining quality of service level or current grade list contains only one quality of service level or grade at block 810, and the subject's last feedback is positive (i.e., “acceptable”) at block 812 then the current survey quality of service level or grade is marked with the “lowest acceptable grade” at block 814 and the survey is ended for the SP. If the current remaining quality of service level or grade list contains only one quality of service level or grade at block 810, and the SP's feedback is not positive (i.e., “not acceptable”) at block 812 and the current remaining grade list is the lower portion of the “last previous” iteration of the remaining grade list at block 816, then the grade at the middle point of “last previous” remaining grade list is marked as the “lowest acceptable quality of service level or grade” for the survey with this SP at block 818 and the survey is ended. If the current remaining grade list contains only one grade at block 810, and the subject's feedback is not positive (i.e., “not acceptable”) at block 812 and this remaining grade list is the upper portion of the “last previous” iteration of the remaining grade list at block 816, then the grade at the “upper extreme” point of “last previous” remaining grade list is marked as the “lowest acceptable quality of service level or grade” for the survey with this SP at block 820 and the survey is ended.

If the current remaining grade list contains more than one grade at block 810, and the SP's feedback is positive at block 822, then the survey procedure lets the next iteration of the remaining grade list be the sub-list consisting of all grades between the current “upper extreme” and the “middle point”, exclusively, at block 826. The next iteration is then provided by proceeding to block 806. If the current remaining grade list contains more than one grade or quality of service level at block 810, and the SP's feedback is negative at block 822, then the next iteration of the remaining grade list is the sub-list consisting of all grades between the current “lower extreme” and the “middle point”, exclusively, at block 824. The next survey iteration is then provided by proceeding to block 806. The process yields one “lowest acceptable grade” for each individual SP. Combining such “lowest acceptable grades” for all SPs yields statistics of min, max, mean, and standard deviation. The overall lowest acceptable grade or quality of service level is determined using all these statistics. The overall lowest acceptable grade or quality of service level is determined based on programmable business rules, e.g., the percent of the market population that the service quality should satisfy.

In another embodiment, instead of the overall lowest acceptable grade or quality of service level, each individual lowest acceptable grade or quality of service level for each SP may be saved for later use, creating a set of multiple lowest acceptable grades such as described below in paragraph [0063]. Further, if the procedure described above as depicted in FIG. 8 is integrated with the procedure described above as depicted in FIG. 7, then the above process also yields a quality of service level rating for each quality of service level sample (i.e., asking “how would you rate the quality of this sample using a 5-level scale”, in addition to asking for “acceptance”). The rules of collecting quality of service level ratings can follow ITU-T P.800. This procedure can be used to refine the preliminary grade or quality of service level list described in FIG. 7.

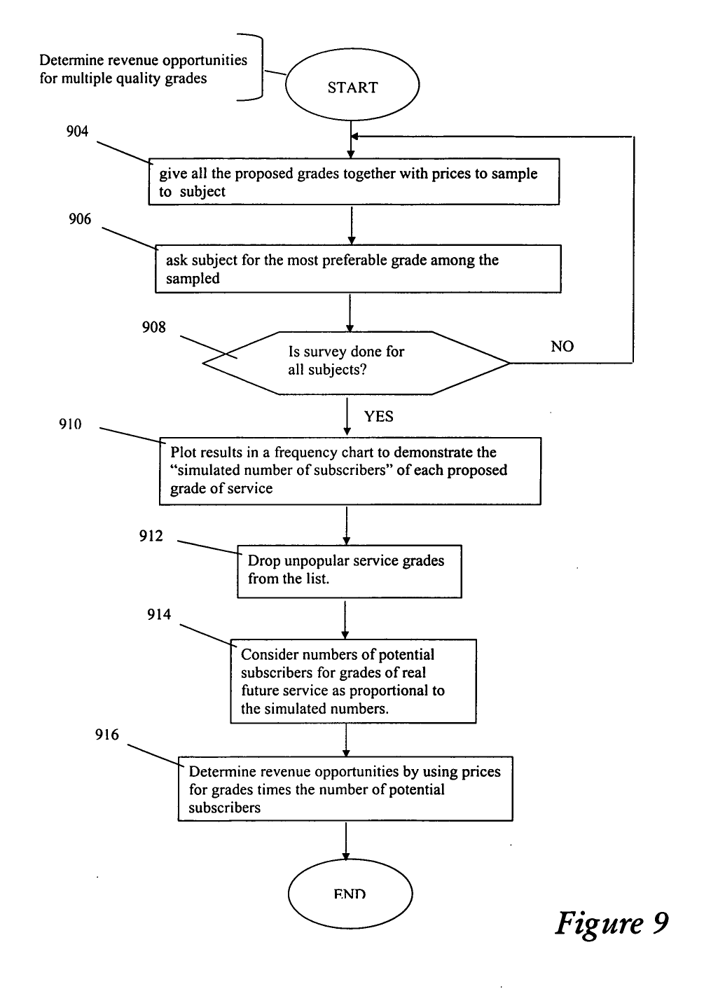

Turning now to FIG. 9, FIG. 9 is a flow chart illustrating another embodiment for determining revenue opportunities for multiple quality grades or quality of service levels (used once for a service feature and pricing scheme). One simple approach to determine service revenue opportunities is to use a single set of samples for all survey subjects, as described below. Another approach is to use different sample sets for different subjects, which is also described below, in Paragraph [0063].

All the quality grades or quality of service levels in the list which exceed the overall lowest grade or quality of service level constitute possible candidates for quality of service levels to be surveyed. Among these, some are chosen as proposed service grades and assigned prices. Proposed services grades or quality of service levels prices are chosen using marketing rules and methods. A typical example of a marketing rule may be an offering of two to four quality of service levels or grades, in which a price is selected, based on a rule such as the higher the quality of service level, the higher the price.

The SP can be subjected to the proposed quality of service levels or grades together with associated prices to sample at block 904. The SP is further asked for the most preferable quality of service level or grade among the samples at block 906. It is determined if the survey is done for all subjects at block 908. If the survey is not finished for all subjects at block 908 the procedure proceeds to block 904. If the survey is finished for all subjects at block 908 the results are plotted in a frequency chart to demonstrate the “simulated number of subscribers” for each proposed grade of service at block 910. Some quality of service levels, if unpopular, may be dropped from the selected list of quality of service levels at block 912. The end result after dropping unpopular grades or quality of service levels is a “selected list of grades or quality of service levels” for the service. The numbers of potential subscribers for the quality of service levels of proposed actual or projected actual future service can be considered as proportional to the simulated numbers at block 914. The multiplication factor can be decided with programmable business rules implementing a marketing method. The real revenue opportunities can be determined using the prices for grades times the number of potential subscribers for each grade at block 916.

In an alternative embodiment, a set of proposed service grades for each SP is made for each distinct “lowest acceptable grade” for each SP as determined by each SP in the procedure described above, in paragraph [0059]. That is, there can be multiple sets of proposed service grades and all subjects in this survey procedure with multiple sets of proposed service grade can be the same subjects that participated in the survey procedure that produced the multiple lowest acceptable grades. When choosing the service grades for all the sets, care should be taken to minimize the total number of grades within a set of proposed grades so that each grade is not too close to any other one in its quality score. For some quite high lowest acceptable grades, the corresponding sets of proposed service grades may contain a fewer number of grades than otherwise. Another difference of this alternative embodiment is that in the survey procedure each subject is given a set of proposed service grades selected according to the lowest acceptable grade he or she generated previously. Since the number of grades may be different in different sets of proposed service grades, those subjects who have been more tolerant of quality degradation are given more proposed grades of service than the number grades given to those who have been less tolerant of quality degradation. This alternative embodiment is useful when the lowest acceptable grades generated by all subjects are very diverse in quality.

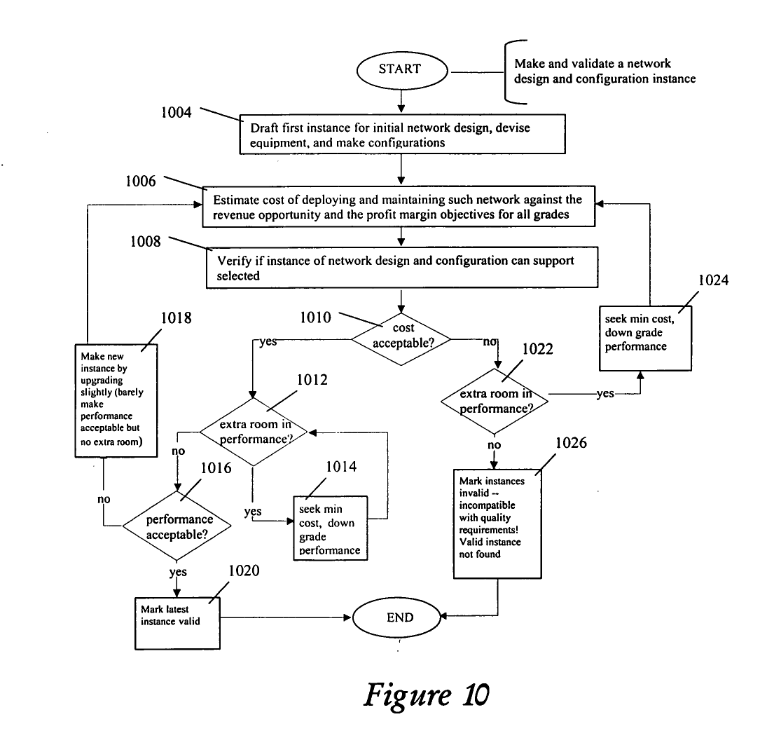

Turning now to FIG. 10, FIG. 10 is a flow chart illustrating another embodiment for determining a network configuration. After a selected list of quality of service levels or grades has been determined, an actual physical network can be designed to meet the selected list of service grades. It is possible to design a single network that supports all the selected service quality of service levels. Alternatively separate overlaying networks can be designed where each network supports a single grade of service or quality of service level. The former design can be more elegant but uses more sophisticated, and thus more expensive, techniques to differentiate the delivery of different grades. Ultimately the business rules based on the packet switched network market economy dictate which approach to take.

Drafting and storing of the initial network design, equipment, and configuration in a first network instance is performed at block 1004. The cost of deploying and maintaining the designed network is weighted against the revenue opportunity for the network as determined above and the profit margin objectives are verified at block 1006. Whether the network design and configuration in the current network instance can support the selected quality grades for the network is verified at block 1008. If the cost is acceptable at block 1010 the procedure continues at block 1012 where it is determined if there is extra room or capacity in the network performance. If there is no room in the performance at block 1012 then it continues to block 1016 to determine if the performance is acceptable. If the performance is acceptable at block 1016 then the latest network instance design and configuration is marked valid at block 1020 and the procedure is ended. If it is determined that there is extra room or capacity in the network performance at block 1012 then the network is downgraded slightly at block 1014 and returned to block 1012. As shown in FIG. 10, a substantially minimum network configuration cost can be achieved iteratively by reducing network performance until extra network performance and associated expense has been reduced while still meeting the performance and quality of service goals. If the performance is not acceptable at block 1016 then the procedure upgrades the network slightly at block 1018 and continues to block 1006. If at block 1010 it is determined that the cost is not acceptable the procedure continues to block 1022 where it is determined if there is extra room in the performance. If there is no extra room in the performance at block 1022 the procedure continues to block 1026 to conclude that the design and configuration is invalid (which usually indicates a need for change in pricing, profit margin, and/or network equipment selection and bargaining) the network instance is marked invalid and the procedure is ended. If it is determined that there is extra room in the performance at block 1022 then the network is downgraded slightly at block 1024 and then continues on to block 1006.

At block 1006, the procedure automatically goes through each user-serving path of the network and aggregates all impairments (e.g., packet transport loss, delay, and jitter) introduced by all equipment along that path and makes end-to-end impairments out of it. The service grade or quality of service level is satisfied when the end-to-end impairments of all the paths are below the service grade requirements. This procedure can aid the network design, in that the procedure proposes improvements based on the verification results of all network paths. For example, if a piece of equipment is only on certain paths and all those paths show a significant performance surplus (e.g., extra capacity), then this piece of equipment can be downgraded to yield a lower cost. Conversely, if all these paths show a performance deficit, then the same piece of equipment can be upgraded.

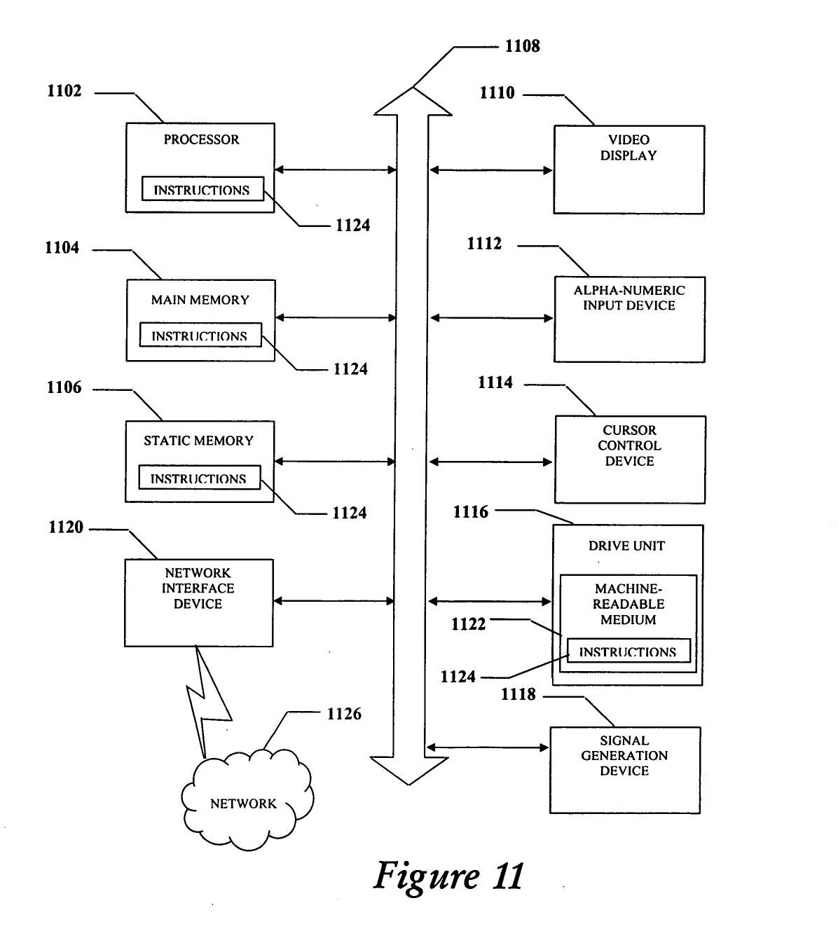

Turning now to FIG. 11, FIG. 11 is a diagrammatic representation of a machine in the form of a computer system 1100 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 1100 may include a processor 1102 (e.g., a central processing unit (CPU), a graphics processing unit (GPU), or both), a main memory 1104 and a static memory 1106, which communicate with each other via a bus 1108. The computer system 1100 may further include a video display unit 1110 (e.g., a liquid crystal display (LCD), a flat panel, a solid state display, or a cathode ray tube (CRT)). The computer system 1100 may include an input device 712 (e.g., a keyboard), a cursor control device 1114 (e.g., a mouse), a disk drive unit 716, a signal generation device 1118 (e.g., a speaker or remote control) and a network interface device 1120.

The disk drive unit 1116 may include a machine-readable medium 1122 on which is stored one or more sets of instructions (e.g., software 1124) embodying any one or more of the methodologies or functions described herein, including those methods illustrated in herein above. The instructions 1124 may also reside, completely or at least partially, within the main memory 1104, the static memory 1106, and/or within the processor 1102 during execution thereof by the computer system 1100. The main memory 1104 and the processor 1102 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 1124, or that which receives and executes instructions 1124 from a propagated signal so that a device connected to a network environment 1126 can send or receive voice, video or data, and to communicate over the network 1126 using the instructions 1124. The instructions 1124 may further be transmitted or received over a network 1126 via the network interface device 1120.

While the machine-readable medium 1122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet-switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Although the invention has been described with reference to several illustrative embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

What is claimed is:

1. A computer readable medium, containing instructions that when executed by a computer perform a method for configuring a packet-switched network, the method comprising:
emulating a variable quality of service for the packet-switched network; and
collecting survey data for the variable quality of service.

2. The medium of claim 1, wherein the method further comprises:
storing a configuration for the packet-switched network in a first network instance; and
configuring the first network instance to a second network instance based on the survey data.

3. The medium of claim 1, the method further comprising:
determining a minimum quality of service from the survey data.

4. The medium of claim 1, wherein in the method, emulating further comprises emulating a plurality of quality of service levels above the minimum quality of service and wherein collecting survey data further comprises collecting survey data to determine a number of subscribers for each of the plurality of quality of service levels.

5. The medium of claim 2, wherein in the method, configuring further comprises configuring the first network instance to the second network instance based on a cost.

6. The medium of claim 5, wherein in the method, the cost further comprises a substantially minimum cost of providing a packet-switched network according to the second network instance.

7. The medium of claim 6, the method further comprising:
calculating a revenue as a sum of the revenue for each quality of service level and configuring the second network instance based on the revenue minus the cost.

8. The medium of claim 1, wherein in the method, the variable quality of service further comprises at least one variable weight impairment selected from a set consisting of delay, loss, jitter and error.

9. A system comprising:
a database for storing a configuration for a packet-switched network in a first network instance;
a network emulator that emulates the configuration for the packet-switched network; and
a control system with access to the first network instance in the database, the control system having a first interface to store the first network instance in the data base, a second interface to command the network emulator emulate a variable quality of service for the first network instance, a third interface to receive survey data for the variable quality of service and a fourth interface to store a configured second network instance based on the survey data.

10. The system of claim 9, the control system further comprising:
a fifth interface to store a minimum quality of service determined from the survey data.

11. The system of claim 10, the control system further comprising:
a sixth interface to send a command to the network emulator to emulate a plurality of quality of service levels above the minimum quality of service and collect survey data to determine a number of subscribers for each of the plurality of quality of service levels.

12. The system of claim 9, the control system further comprising:
a seventh interface to store the configured second network instance based on a substantially minimum cost of providing the packet-switched network.

13. The system of claim 12, the control system further comprising:
a eighth interface to store the second network instance based on the revenue minus the cost.

14. The system of claim 13, wherein the revenue is a sum of the revenue for each quality of service level, wherein the revenue for each quality of service level is derived from the number of projected subscribers who are satisfied for said each quality of service level and the subscription fee for each quality of service level.

15. The system of claim 9, the control system further comprising:
a ninth interface to send a command to the network emulator to vary a weight for an impairment selected from a set consisting of delay, loss, jitter and error.

16. A packet-switched network comprising:
a plurality of network nodes;
a plurality of high speed digital communication links connecting the plurality of network nodes;
a plurality of network components placed in the plurality of nodes wherein the network components are placed in a selected node based on a computer program, wherein the computer program comprises:
instructions to store a network configuration for the packet-switched network in a first network instance;
instructions to emulate a variable quality of service for the first network instance;
instructions to collect survey data for the variable quality of service; and
instructions to configure the first network instance to a second instance based on the survey data.

17. The network of claim 16, wherein the computer program further comprises instructions to determine a minimum quality of service from the survey data.

18. The network of claim 17, wherein the computer program further comprises instructions to emulate a plurality of quality of service levels above the minimum quality of service and collect further survey data to determine a number of subscribers for each of the plurality of quality of service levels.

19. The network of claim 16, wherein the computer program further comprises instructions to configure the initial network instance to the second instance based on a substantially minimum cost.

20. The network of claim 19, wherein the computer program further comprises instructions to calculate the cost as a cost of providing an actual packet-switched network according to the second network.

21. The system of claim 20, wherein the computer program further comprises instructions to calculate a revenue and configuring the second network instance based on the revenue minus the cost.

22. The system of claim 16, wherein the computer program further comprises instructions to vary a weight for an impairment selected from a set consisting of delay, loss, jitter and error.
